(19) United States
(12) Patent Application Publication
(10) Pub. No.: US 2015/0274233 A1
(43) Pub. Date: Oct. 1, 2015

(54) ARTICLE PLACING STRUCTURE FOR MOTORCYCLE

(71) Applicant: HONDA MOTOR CO., LTD., Tokyo (JP)

(72) Inventor: Natsumi HAMADA, Wako-shi (JP)

(73) Assignee: HONDA MOTOR CO., LTD., Tokyo (JP)

(21) Appl. No.: 14/669,470

(22) Filed: Mar. 26, 2015

(30) Foreign Application Priority Data
Mar. 31, 2014 (JP) 2014-073468

(51) Int. Cl. B62J 9/00; B62J 11/00

(52) U.S. Cl. CPC B62J 9/008; B62J 11/00

(57) ABSTRACT

To form an article placing part without a weight increase for a motorcycle including a vehicle body frame having a head pipe on which a steering handlebar is steerably supported and a main frame which extends rearwardly and downwardly from the head pipe. A riding seat is supported on the vehicle body frame with a fuel tank disposed between the steering handlebar and the riding seat and supported on the main frame. An article placing part is arranged on an outer lateral side of a fuel tank in such a way so as to be supported on the fuel tank.

### CROSS-REFERENCE TO RELATED APPLICATIONS

The present application claims priority under 35 USC 119 to Japanese Patent Application No. 2014-073468 filed Mar. 31, 2014 the entire contents of which are hereby incorporated by reference.

### BACKGROUND OF THE INVENTION

1. Field of the Invention

The present invention relates to a motorcycle including a vehicle body frame having a head pipe on which a steering handlebar is steerably supported and a main frame extending rearwardly and downwardly from the head pipe with a riding seat supported on the vehicle body frame. A fuel tank is disposed between the steering handlebar and the riding seat and supported on the main frame. More specifically, the present invention relates to an improvement in an article placing structure.

2. Description of Background Art

As set forth in Japanese Patent Application Publication No. Hei 7-215253, a motorcycle is known that includes a main frame extending rearwardly and downwardly from a head pipe on which a steering handlebar is steerably supported with a fuel tank supported on the main frame. A cowling covers a front portion of the fuel tank from lateral sides. An article housing part is formed inside the cowling with a lid supported on the cowling for opening and closing the article housing part.

In the structure as disclosed in Japanese Patent Application Publication No. Hei 7-215253, when an article is placed on the cowling, reinforcement is required to increase the strength and rigidity of the cowling. The reinforcement in turn causes an increase in the weight.

### SUMMARY AND OBJECTS OF THE INVENTION

The present invention has been made in view of such a circumstance. It is an object of an embodiment of the present invention is to provide an article placing structure for a motorcycle designed such that an article can be placed, without increasing the weight.

For the purpose of achieving the above-mentioned object, an embodiment of the present invention provides an article placing structure for a motorcycle including a vehicle body frame including a head pipe on which a steering handlebar is steerably supported and a main frame which extends rearwardly and downwardly from the head pipe with a riding seat supported on the vehicle body frame. A fuel tank is disposed between the steering handlebar and the riding seat and supported on the main frame. An article placing part is arranged on an outer lateral side of the fuel tank in such a way so as to be supported on the fuel tank.

According to an embodiment of the present invention, the article placing part is configured to hold an article in such a way so as to expose the article to an outside.

According to an embodiment of the present invention, a fixing member to which any one of an elastic band and a side carrier is fixable, and a hook with which the elastic band is detachably engageable are fixed to an outer side surface of the fuel tank.

According to an embodiment of the present invention, the article placing part is supported on the fuel tank which has high strength and rigidity. Thus, major reinforcement is not required. Accordingly, the article placing part can be formed without a weight increase.

According to an embodiment of the present invention, an article held by the article placing part is exposed to the outside. Thus, a wet article such as a raincoat or sandals can be quickly dried by utilizing air flow during operation of the vehicle. Accordingly, the usefulness is improved.

According to an embodiment of the present invention, the article placing part is formed by fixing the side carrier to the fixing member or by engaging the elastic band, which is fixed to the fixing member, with the hook. Thus, an article can be held in a selective way. Accordingly, the usefulness is improved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a right-side view of a motorcycle;

FIG. 2 is a perspective view of a part of a fuel tank seen from a right rear side in a case where an elastic band is used; and

FIG. 3 is a perspective view of a part of the fuel tank seen from a right rear side in a case where a side carrier is used.

### DETAILED DESCRIPTION OF THE PREFERRED EMBODIMENTS

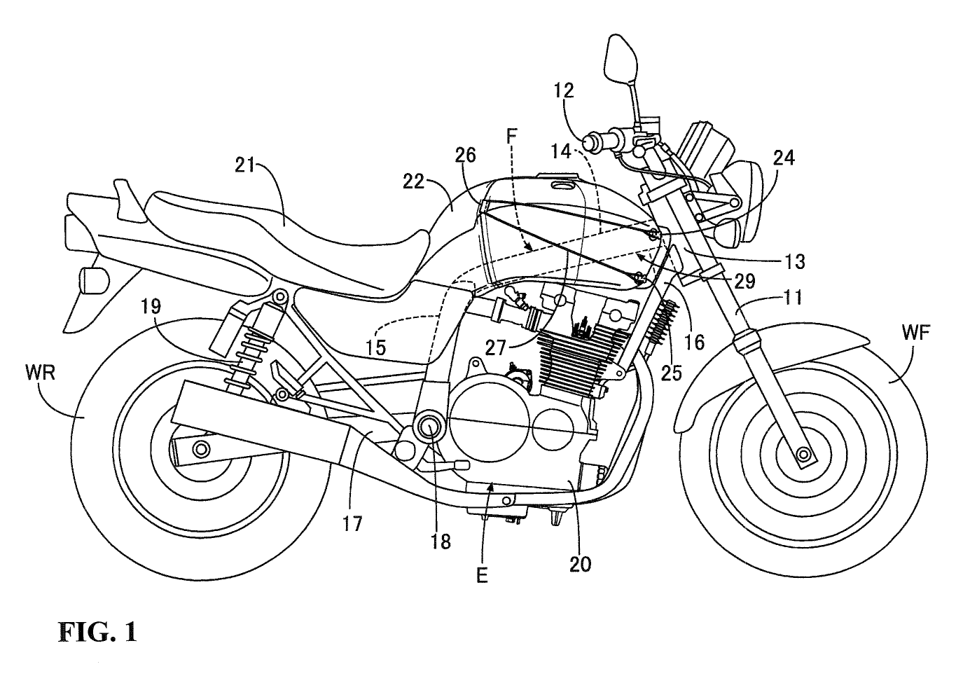

Hereinbelow, an embodiment of the present invention will be described with reference to accompanying FIGS. 1 to 3. Note that in the following description, front, rear, left, right, upper, and lower refer to directions are based on the perspective of a rider riding a motorcycle.

As illustrated in FIG. 1, a vehicle body frame F of this motorcycle includes a head pipe 13 on which a front fork 11 and a steering handlebar 12 are steerably supported with a front wheel WF being rotatably supported on a lower end portion of the front fork 11. A main frame 14 extends rearwardly and downwardly from the head pipe 13 with a center frame 15 extending downwardly from the rear end of the main frame 14. A down frame 16 extends rearwardly and downwardly from the head pipe 13 at a steeper angle than the main frame 14. The main frame 14 and the center frame 15 are formed integrally with each other.

A front end portion of a swingarm 17, on a rear end portion of which a rear wheel WR is rotatably supported, is swingably supported on a lower portion of the center frame 15 through a pivot 18. A rear shock absorber 19 is provided between a rear portion of the swingarm 17 and the vehicle body frame F.

An engine body 20 of an internal combustion engine E which produces motive power to drive the rear wheel WR is disposed under the main frame 14 and supported on the down frame 16 and the center frame 15.

A riding seat 21 is supported on the vehicle body frame F at a position rearwardly of the engine body 20. A fuel tank 22 is disposed between the riding seat 21 and the steering handlebar 12 and supported on the main frame 14 of the vehicle body frame F.

An article placing part 29 is arranged on an outer lateral side of the fuel tank 22 in such a way so as to be supported on the fuel tank 22.

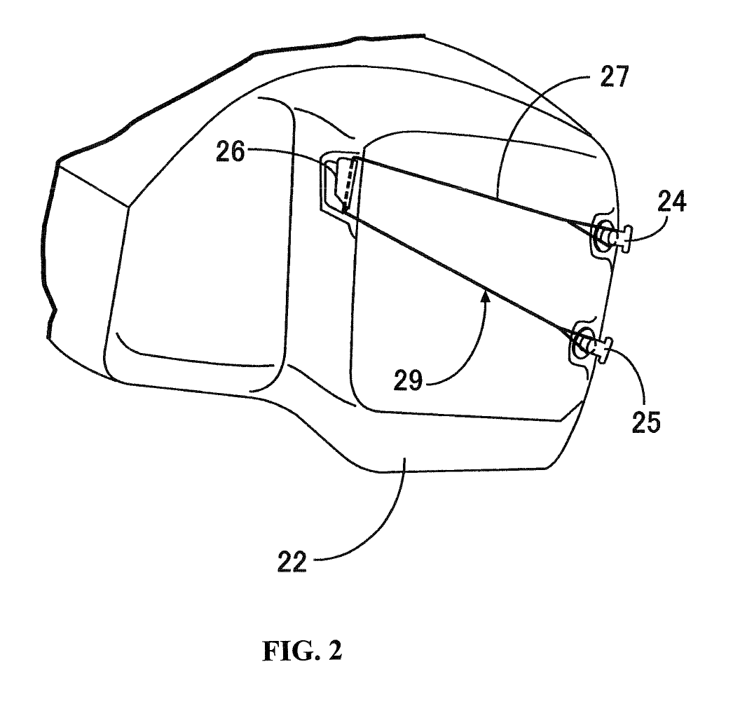

As illustrated in FIG. 2, a pair of fixing members 24, 25 and a hook 26 are fixed to the outer side surface of the fuel tank 22, for example. Both fixing members 24, 25 are fixed to a front portion of the outer side surface of the fuel tank 22 at positions separated from each other in the vertical direction. The hook 26 is fixed to a rear portion of the outer side surface of the fuel tank 22.

An elastic band 27 can be fixed to the fixing members 24, 25. By detachably engaging the elastic band 27 with the hook 26, the article placing part 29 is formed which holds an article in cooperation with the outer side surface of the fuel tank 22 in such a way so as to expose the article to the outside.

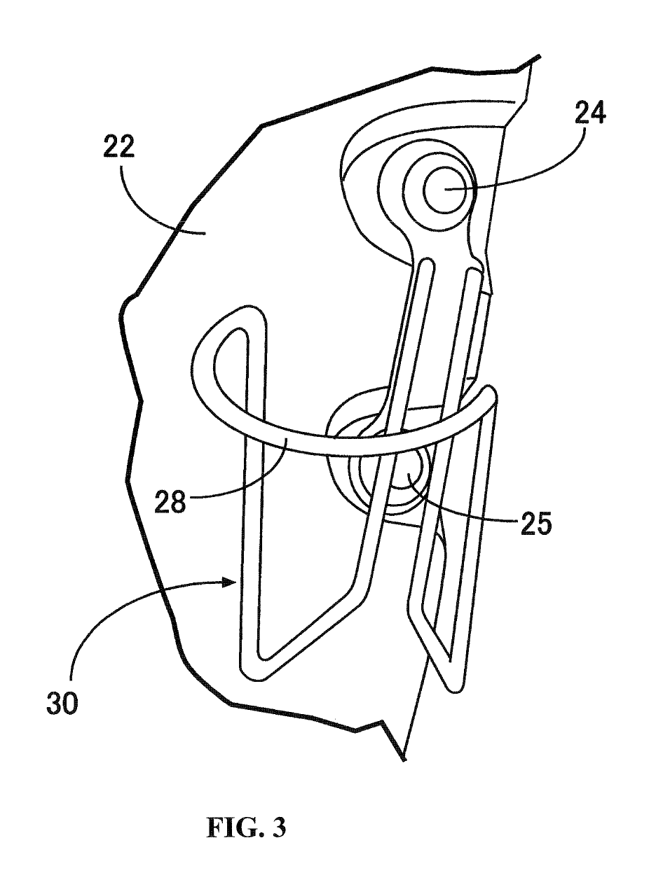

Referring to FIG. 3, a side carrier 28, formed by bending a wire material, for example, can be attached to the fixing members 24, 25 on the outer lateral side of the fuel tank 22. In this way, an article placing part 30 for holding an article in such a way so as to expose the article to the outside can be formed.

Next, the operations and effects of this embodiment will be described. The article placing part 29, 30 is arranged on the outer lateral side of the fuel tank 22 in such a way as to be supported on the fuel tank 22. Thus, the article placing part 29, 30 is supported on the fuel tank 22 which has high strength and rigidity. Therefore, major reinforcement is not required. Accordingly, the article placing part 29, 30 can be formed without an increase in the weight.

Moreover, the article placing part 29, 30 is configured to hold an article in such a way so as to expose the article to the outside. Thus, if, for example, a wet article such as a raincoat or sandals is placed on the article placing part 29, the article can be quickly dried by utilizing a flow of air. Accordingly, the usefulness is improved.

Further, the fixing members 24, 25 to which any one of the elastic band 27 and the side carrier 28 is fixable and the hook 26 with which the elastic band 27 is detachably engageable are fixed to the outer side surface of the fuel tank 22. Thus, an article can be held in a selective way by forming the article placing part 30 by fixing the side carrier 28 to the fixing members 24, 25 or by forming the article placing part 29 by engaging the elastic band 27, which is fixed to the fixing members 24, 25, with the hook 26. Accordingly, the usefulness is improved.

Although the embodiment of the present invention is described above, the present invention is not limited to the above embodiment. Various design changes can be made without departing from the present invention described in the scope of claims.

For example, in the above embodiment, the fixing members 24, 25 are attached directly to the side surface of the fuel tank 22. However, the fixing members may be attached to the fuel tank 22 through a cover member covering the fuel tank from the lateral side.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An article placing structure for a motorcycle comprising:
a vehicle body frame including a head pipe on which a steering handlebar is steerably supported and a main frame extending rearwardly and downwardly from the head pipe;
a riding seat supported on the vehicle body frame;
a fuel tank disposed between the steering handlebar and the riding seat and supported on the main frame; and
an article placing part is arranged on an outer lateral side of the fuel tank in such a way so as to be supported on the fuel tank.

2. The article placing structure for a motorcycle according to claim 1, wherein the article placing part is configured to hold an article in such a way so as to expose the article to ambient air.

3. The article placing structure for a motorcycle according to claim 1, wherein a fixing member to which any one of an elastic band and a side carrier is fixable, and a hook with which the elastic band is detachably engageable are fixed to the outer lateral side of the fuel tank.

4. The article placing structure for a motorcycle according to claim 2, wherein a fixing member to which any one of an elastic band and a side carrier is fixable, and a hook with which the elastic band is detachably engageable are fixed to the outer lateral side of the fuel tank.

5. The article placing structure for a motorcycle according to claim 1, further including at least one fixing member being secured to a front portion of the fuel tank and at least one hook being secured to a rear portion of the fuel tank, wherein said article placing part is stretched between said at least one fixing member being secured to a front portion of the fuel tank to the at least one hook secured to a rear portion of the fuel tank for securing an article between the article placing part and the outer lateral side of the fuel tank.

6. The article placing structure for a motorcycle according to claim 2, further including at least one fixing member being secured to a front portion of the fuel tank and at least one hook being secured to a rear portion of the fuel tank, wherein said article placing part is stretched between said at least one fixing member being secured to a front portion of the fuel tank to the at least one hook secured to a rear portion of the fuel tank for securing an article between the article placing part and the outer lateral side of the fuel tank.

7. The article placing structure for a motorcycle according to claim 5, wherein the at least one fixing member secured to the front portion of the fuel tank includes two fixing members being spaced a predetermined vertical distance therebetween.

8. The article placing structure for a motorcycle according to claim 6, wherein the at least one fixing member secured to the front portion of the fuel tank includes two fixing members being spaced a predetermined vertical distance therebetween.

9. The article placing structure for a motorcycle according to claim 5, wherein said article placing part is an elastic member for resiliently securing an article between the elastic member and the outer lateral side of the fuel tank.

10. The article placing structure for a motorcycle according to claim 6, wherein said article placing part is an elastic member for resiliently securing an article between the elastic member and the outer lateral side of the fuel tank.

11. An article placing structure for a motorcycle comprising:
a fuel tank secured on a main frame of the motorcycle; and
an article placing part secured to an outer lateral side of the fuel tank for resiliently biasing an article between the article placing part and the outer lateral side of the fuel tank for supporting an article on the fuel tank.

12. The article placing structure for a motorcycle according to claim 11, wherein the article placing part is configured to hold an article in such a way so as to expose the article to ambient air.

13. The article placing structure for a motorcycle according to claim 11, wherein a fixing member to which any one of an elastic band and a side carrier is fixable, and a hook with which the elastic band is detachably engageable are fixed to the outer lateral side of the fuel tank.

14. The article placing structure for a motorcycle according to claim 12, wherein a fixing member to which any one of an elastic band and a side carrier is fixable, and a hook with which the elastic band is detachably engageable are fixed to the outer lateral side of the fuel tank.

15. The article placing structure for a motorcycle according to claim 11, further including at least one fixing member being secured to a front portion of the fuel tank and at least one hook being secured to a rear portion of the fuel tank, wherein said article placing part is stretched between said at least one fixing member being secured to a front portion of the fuel tank to the at least one hook secured to a rear portion of the fuel tank for securing an article between the article placing part and the outer lateral side of the fuel tank.

16. The article placing structure for a motorcycle according to claim 12, further including at least one fixing member being secured to a front portion of the fuel tank and at least one hook being secured to a rear portion of the fuel tank, wherein said article placing part is stretched between said at least one fixing member being secured to a front portion of the fuel tank to the at least one hook secured to a rear portion of the fuel tank for securing an article between the article placing part and the outer lateral side of the fuel tank.

17. The article placing structure for a motorcycle according to claim 15, wherein the at least one fixing member secured to the front portion of the fuel tank includes two fixing members being spaced a predetermined vertical distance therebetween.

18. The article placing structure for a motorcycle according to claim 16, wherein the at least one fixing member secured to the front portion of the fuel tank includes two fixing members being spaced a predetermined vertical distance therebetween.

19. The article placing structure for a motorcycle according to claim 15, wherein said article placing part is an elastic member for resiliently securing an article between the elastic member and the outer lateral side of the fuel tank.

20. The article placing structure for a motorcycle according to claim 16, wherein said article placing part is an elastic member for resiliently securing an article between the elastic member and the outer lateral side of the fuel tank.
